(19) United States
(12) Patent Application Publication
(10) Pub. No.: US 2006/0045692 A1
(43) Pub. Date: Mar. 2, 2006

(54) Truck deck mounted cargo handling apparatus

(76) Inventor: Hilton Mills, Calgary (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/149,032

(22) Filed: Jun. 8, 2005

(30) Foreign Application Priority Data
Jun. 22, 2004 (CA) 2,472,361

(51) Int. Cl. B60P 1/04

(52) U.S. Cl. 414/477

(57) ABSTRACT

A truck deck mounted cargo handling apparatus includes a fixed support, a pivoting support and a telescopic support. The pivoting support is pivotally secured to the fixed support for movement about a horizontal pivot axis. The telescopic support is secured to the pivoting support and is positioned parallel to a longitudinal axis of the fixed support when the pivoting support is in a transport position. A cargo carrier is provided which rests upon the fixed support. The cargo carrier is either pushed from or pulled onto the fixed support as the pivoting support pivots between the transport position to a loading position. The cargo carrier is moved axially along the fixed support as the telescopic support expands or retracts.

### FIELD OF THE INVENTION

The present invention relates to a truck deck mounted cargo handling apparatus.

### BACKGROUND OF THE INVENTION

U.S. Pat. No. 6,152,674 (Ogrodnick 2000) discloses a truck deck mounted cargo handling apparatus which is capable of moving a cargo carrier from a truck deck to a ground level loading and unloading position.

### SUMMARY OF THE INVENTION

The present invention relating to an alternative configuration of truck deck mounted cargo handling apparatus.

According to the present invention there is provided a truck deck mounted cargo handling apparatus which includes an elongate fixed support adapted to be affixed to a truck deck. The fixed support having a longitudinal axis, an upper portion, a lower portion, a forward end and rearward end. A pivoting support is provided having a first end and second end. The first end is pivotally secured to the lower portion near the rearward end of the fixed support for movement about a horizontal pivot axis positioned transverse to the longitudinal axis. Pivotal movement is between a transport position extending toward the forward end of the fixed support parallel to the longitudinal axis and a loading position extending past the lower portion at the rearward end of the fixed support parallel to the longitudinal axis. A telescopic support is secured to the second end of the pivoting support. The telescopic support is parallel to the longitudinal axis of the fixed support when the pivoting support is in the transport position. The telescopic support has an attachment end extending toward the forward end of the fixed support. A cargo carrier is provided which is adapted to rest upon and be supported by the upper portion of the fixed support. The cargo carrier is pivotally secured to the attachment end of the telescopic support for pivotal movement about a horizontal pivot axis positioned transverse to the longitudinal axis. A first telescopic actuator is secured between the fixed support and the pivoting support. The first telescopic actuator telescopically expands to pivot the pivoting support from the transport position to the loading position. The cargo carrier is pushed from the upper portion of the fixed support as the pivoting support pivots from the transport position to the loading position and is pulled onto the upper portion of the fixed support as the pivoting support pivots from the loading position to the transport position. A second telescopic actuator is provided which is adapted to extend and retract the telescopic support. The cargo carrier is pushed along the upper portion of the fixed support toward the forward end as the telescopic support expands and is pulled along the upper portion of the fixed support toward the rearward end as the telescopic support retracts.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a side elevation view in partial section of the truck deck mounted cargo handling apparatus in accordance with the teachings of the invention.

FIG. 2 is a side elevation view of the truck deck mounted cargo handling apparatus of FIG. 1 with the telescopic support member retracted.

FIG. 3 is a side elevation view of the truck deck mounted cargo handling apparatus of FIG. 1 with the telescopic actuator slightly extended.

FIG. 4 is a side elevation view of the truck deck mounted cargo handling apparatus of FIG. 1 with the telescopic actuator further extended.

FIG. 5 is a side elevation view of the truck deck mounted cargo handling apparatus of FIG. 1 with the cargo carrier deck engaging the ground.

FIG. 6 is a rear perspective view of the truck mounted cargo handling apparatus of FIG. 1 in a loading position.

FIG. 7 is a front perspective view of the truck mounted cargo handling apparatus of FIG. 1.

### DETAILED DESCRIPTION OF THE PREFERRED EMBODIMENT

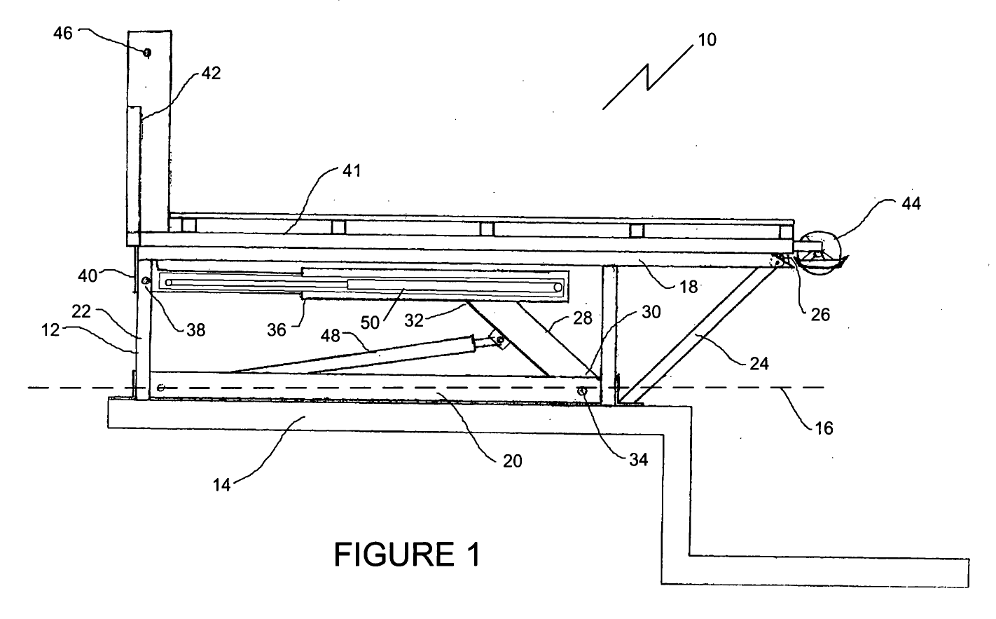

The preferred embodiment, a truck deck mounted cargo handling apparatus generally identified by reference numeral 10, will now be described with reference to FIGS. 1 through 7.

Structure and Relationship of Parts:

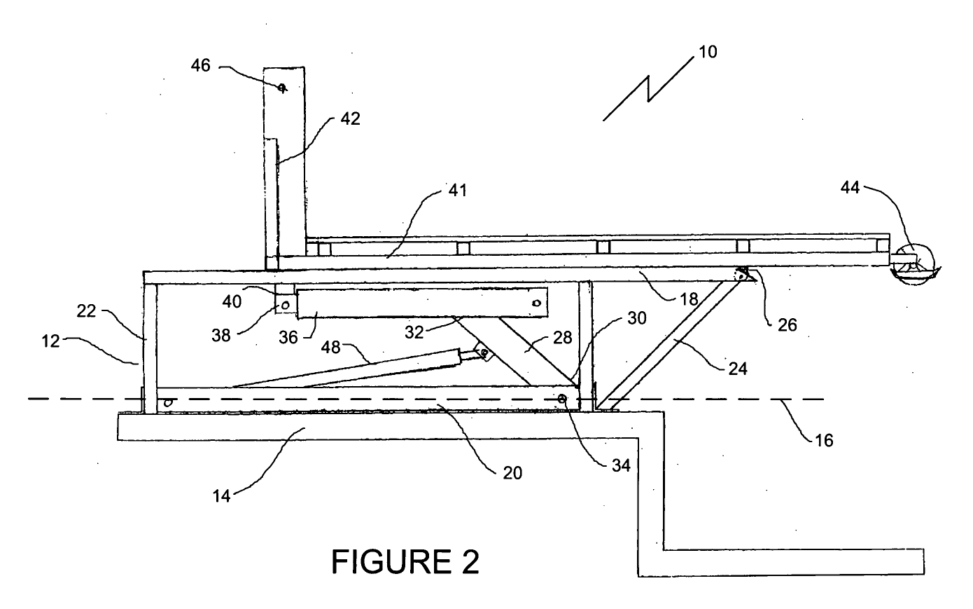

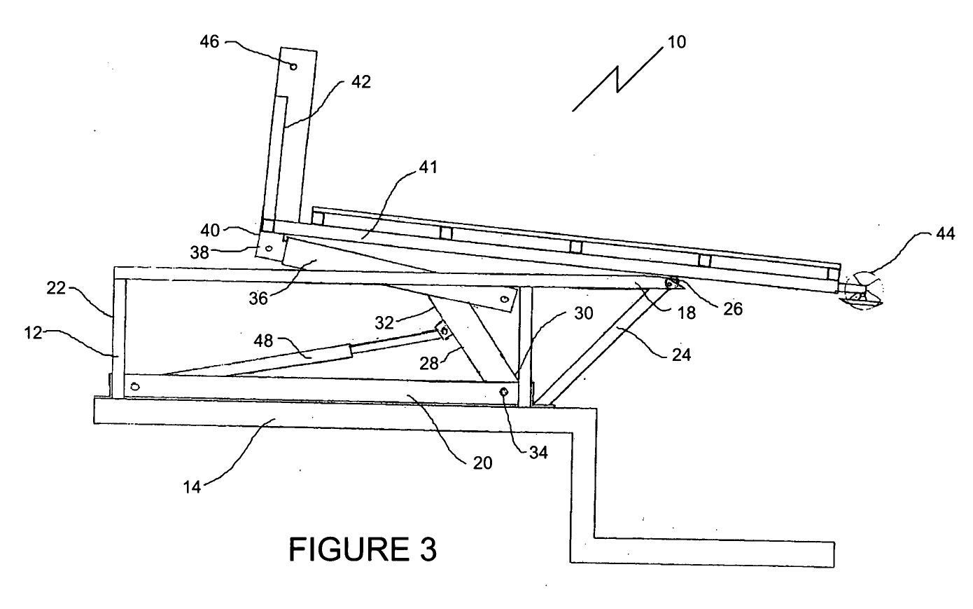

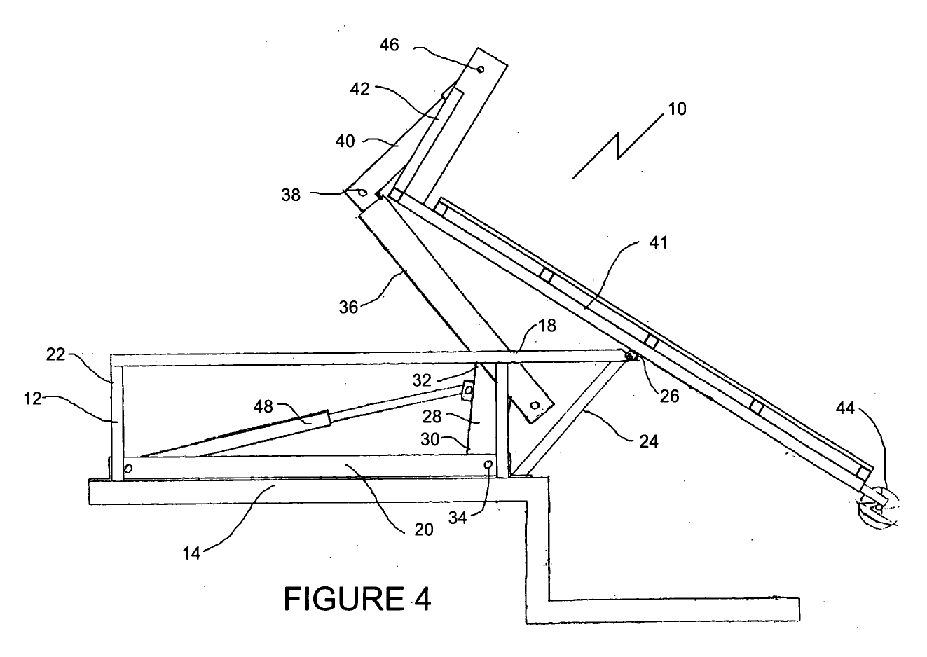

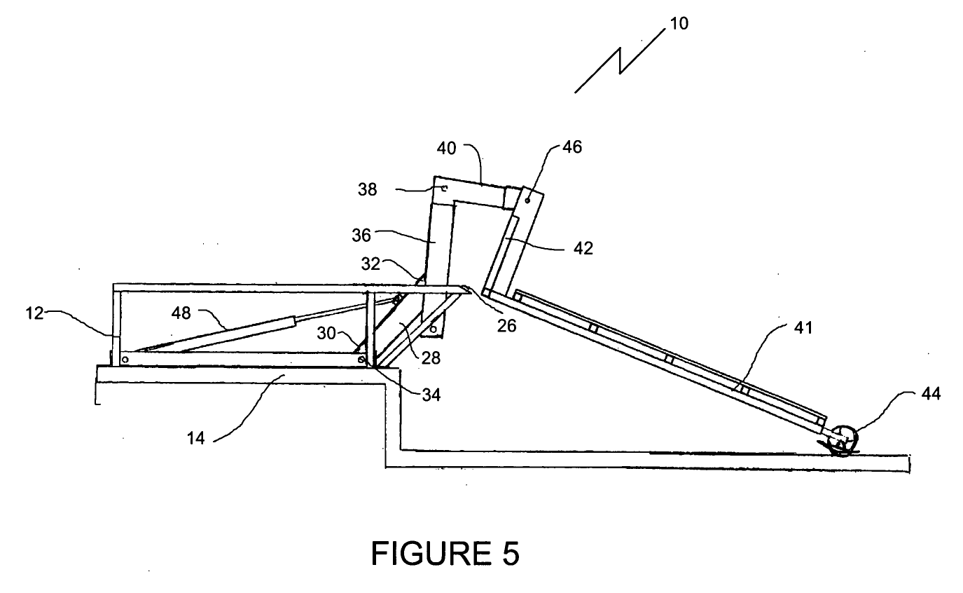

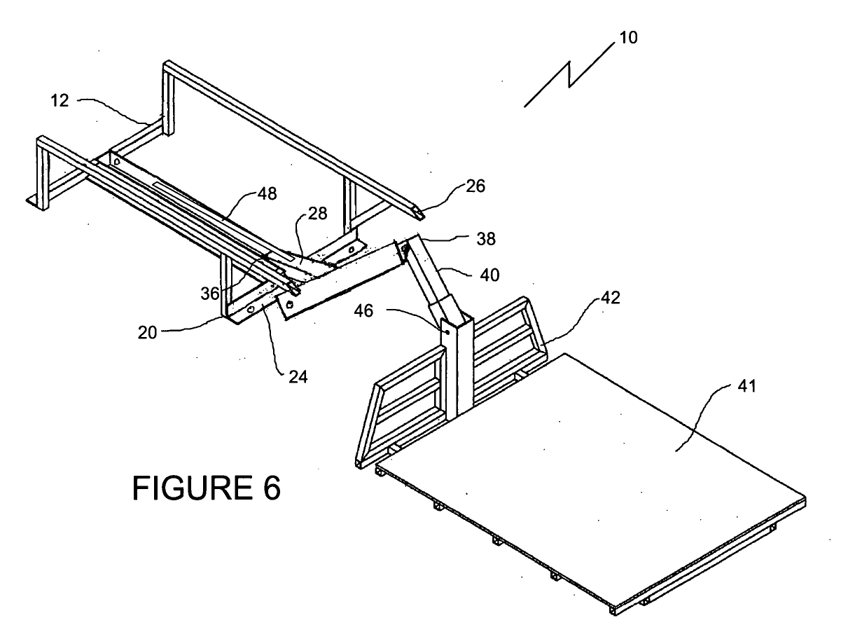

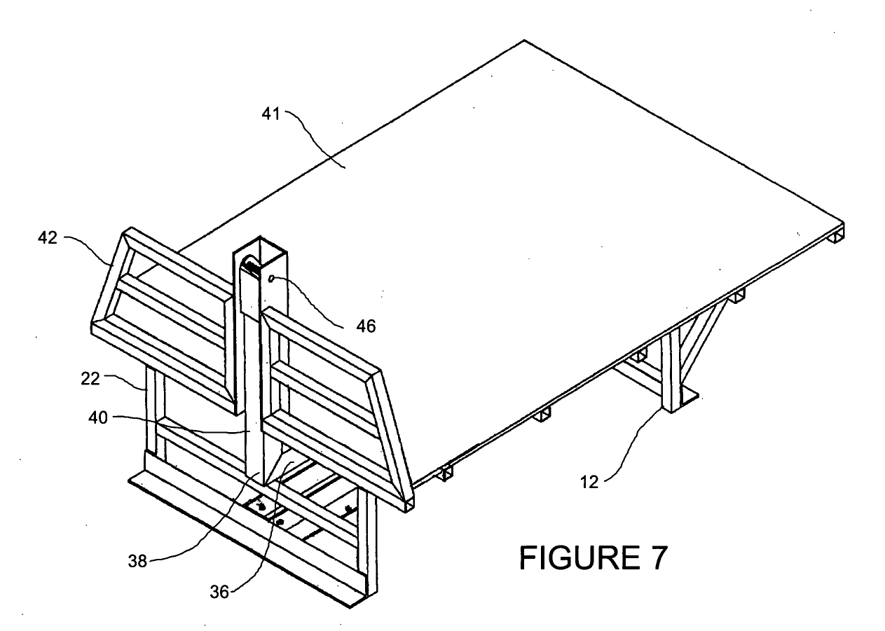

Referring now to FIG. 1, truck deck mounted cargo handling apparatus 10 is shown. There is an elongate fixed support frame 12 adapted to be affixed to a truck deck, represented by platform 14. Fixed support frame 12 has a longitudinal axis 16, an upper portion 18, a lower portion 20, a forward end 22 and a rearward end 24. Upper portion 18 at rearward end 24 has rollers 26. There is also a pivoting support member 28 which has a first end 30 and second end 32. First end 30 is pivotally secured to lower portion 20 near rearward end 24 of fixed support frame 12 for movement about a horizontal pivot axis 34 positioned transverse to longitudinal axis 16. First end 30 can therefore move between a transport position as shown in FIG. 1 extending toward forward end 22 of fixed support frame 12 parallel to longitudinal axis 16 and a loading position as shown in FIG. 6 extending past lower portion 20 at rearward end 24 of fixed support frame 12 parallel to longitudinal axis 16. A telescopic support member 36 is secured to second end 32 of pivoting support member 28. Telescopic support member 36 is parallel to axis 16 of fixed support frame 12 when pivoting support member 28 is in the transport position. Referring now to FIG. 7, telescopic support member 36 has an attachment end 38 that extends toward forward end 22 of fixed support frame 12 with an attachment mast 40 extending vertically from attachment end 38. Referring again to FIG. 1, a cargo carrier deck 41 is adapted to rest upon and be supported by upper portion 18 of the fixed support frame 12, where cargo carrier deck 41 has a forward rail 42 and rearward rollers 44. Cargo carrier deck 41 is pivotally secured to mast 40 at attachment end 38 of telescopic support member 36 for pivotal movement about a horizontal pivot axis 46 positioned transverse to longitudinal axis 16. There is also a first telescopic actuator 48 secured between fixed support frame 12 and pivoting support member 28, where actuator 48 telescopically expands to pivot pivoting support member 28 from the transport position shown in FIG. 1 to the loading position shown in FIG. 6, such that cargo carrier deck 41 is pushed from upper portion 18 of fixed support frame 12 as pivoting support member 28 pivots from the transport position to the loading position and is pulled onto upper portion 18 of fixed support frame 12 as pivoting support member 28 pivots from the loading position to the transport position. Referring to FIGS. 3 and 4, rollers 26 facilitate the movement of cargo carrier deck 41 by reducing friction during the transition between positions. In addition, referring to FIG. 5, rearward rollers 44 facilitate the transition by reducing friction between cargo carrier deck 41 and the ground, which may be significant if the load on cargo carrier deck 41 is heavy. Also included, referring to FIG. 1, is a second telescopic actuator 50 which is located within telescopic support member 36 in the embodiment depicted and seen in the partial sectional view of telescopic support member 36. Second telescopic actuator 50 is adapted to extend and retract telescopic support member 36, such that cargo carrier deck 41 is pushed along upper portion 18 of fixed support frame 12 toward forward end 22 as telescopic support member 36 expands, resulting in the position shown in FIG. 1 and is pulled along upper portion 18 of fixed support member 12 toward rearward end 24 as telescopic support member 38 retracts to the position shown in FIG. 2. Telescopic support member 36 stays in the retracted position during the transition from the transport position to the loading position.

Operation:

The operation of truck deck mounted cargo handling apparatus 10 will now be discussed with reference to FIGS. 1 through 7. Referring now to FIG. 1, truck deck mounted cargo handling apparatus 10 is in a transport position. When it is desired to transition to a loading position, telescopic support member 36 is retracted by second telescopic actuator 50 to the position shown in FIG. 2. Referring now to FIGS. 3 and 4, first telescopic actuator 48 then begins to extend, which in turn causes pivoting support member 28 to pivot about horizontal pivoting axis 34 This in turn causes attachment end 38 of telescopic support member 36 to raise. As attachment end 38 is raised, cargo carrier deck 41 pivots with respect to attachment mast 40 about horizontal pivot axis 46 and cargo carrier deck 41 begins to tilt and slide along rollers 26. First telescopic actuator 48 continues to extend, and, referring now to FIG. 5, rearward rollers 44 engage the ground and facilitate the movement of cargo carrier deck 41 as truck deck mounted cargo handling apparatus 10 is transitioned to the loading position shown in FIG. 6. To transition back into the transport position, the process is reversed by first retracting first telescopic actuator 48, and once fully retracted, extending second telescopic actuator 50 to return to the position shown in FIG. 1.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims. For example, while a fixed support frame has been described, the frame could be replaced with any support structure, such as a box. Also, support members are shown as a single bar could be replaced with any type of suitable support, such as multiple bars or reinforced sheets.

The embodiment of the invention in which an exclusive property or privilege is claimed are defined as follows:

1. A truck deck mounted cargo handling apparatus, comprising:
an elongate fixed support adapted to be affixed to a truck deck, the fixed support having a longitudinal axis, an upper portion, a lower portion, a forward end and rearward end;
a pivoting support having a first end and second end, the first end being pivotally secured to the lower portion near the rearward end of the fixed support for movement about a horizontal pivot axis positioned transverse to the longitudinal axis between a transport position extending toward the forward end of the fixed support parallel to the longitudinal axis and a loading position extending past the lower portion at the rearward end of the fixed support parallel to the longitudinal axis;
a telescopic support secured to the second end of the pivoting support, the telescopic support being parallel to the axis of the fixed support when the pivoting support is in the transport position, the telescopic support having an attachment end extending toward the forward end of the fixed support;
a cargo carrier adapted to rest upon and be supported by the upper portion of the fixed support;
means for pivotally securing the cargo carrier to the attachment end of the telescopic support for pivotal movement about a horizontal pivot axis positioned transverse to the longitudinal axis;
a first telescopic actuator secured between the fixed support and the pivoting support, the first telescopic actuator telescopically expanding to pivot the pivoting support from the transport position to the loading position, such that the cargo carrier is pushed from the upper portion of the fixed support as the pivoting support pivots from the transport position to the loading position and is pulled onto the upper portion of the fixed support as the pivoting support pivots from the loading position to the transport position; and
a second telescopic actuator adapted to extend and retract the telescopic support, such that the cargo carrier is pushed along the upper portion of the fixed support toward the forward end as the telescopic support expands and is pulled along the upper portion of the fixed support toward the rearward end as the telescopic support retracts.

2. A truck deck mounted cargo handling apparatus, comprising:
an elongate fixed support frame adapted to be affixed to a truck deck, the fixed support frame having a longitudinal axis, an upper portion, a lower portion, a forward end and a rearward end, the upper portion at the rearward end having rollers;
a pivoting support member having a first end and second end, the first end being pivotally secured to the lower portion near the rearward end of the fixed support frame for movement about a horizontal pivot axis positioned transverse to the longitudinal axis between a transport position extending toward the forward end of the fixed support frame parallel to the longitudinal axis and a loading position extending past the lower portion at the rearward end of the fixed support frame parallel to the longitudinal axis;
a telescopic support member secured to the second end of the pivoting support member, the telescopic support member being parallel to the axis of the fixed support frame when the pivoting support member is in the transport position, the telescopic support member having an attachment end extending toward the forward end of the fixed support frame, an attachment mast extending vertically from the attachment end;
a cargo carrier deck adapted to rest upon and be supported by the upper portion of the fixed support frame, the cargo carrier deck having a forward rail and at least one rearward roller, the cargo carrier being pivotally secured to the mast at the attachment end of the telescopic support for pivotal movement about a horizontal pivot axis positioned transverse to the longitudinal axis;
a first telescopic actuator secured between the fixed support frame and the pivoting support member, the actuator telescopically expanding to pivot the pivoting support member from the transport position to the loading position, such that the cargo carrier deck is pushed from the upper portion of the fixed support frame as the pivoting support member pivots from the transport position to the loading position and is pulled onto the upper portion of the fixed support frame as the pivoting support member pivots from the loading position to the transport position; and
a second telescopic actuator adapted to extend and retract the telescopic support member, such that the cargo carrier deck is pushed along the upper portion of the fixed support frame toward the forward end as the telescopic support member expands and is pulled along the upper portion of the fixed support member toward the rearward end as the telescopic support member retracts.
